(19) United States
(12) Patent Application Publication
(10) Pub. No.: US 2014/0333608 A1
(43) Pub. Date: Nov. 13, 2014

(54) DISPLAY DRIVER IC

(71) Applicant: Renesas SP Drivers Inc., Tokyo (JP)

(72) Inventors: Yosuke Okairi, Kodaira (JP); Kota Kitamura, Kodaira (JP)

(73) Assignee: Renesas SP Drivers Inc., Tokyo (JP)

(21) Appl. No.: 14/264,151

(22) Filed: Apr. 29, 2014

(30) Foreign Application Priority Data
May 7, 2013 (JP) 2013-097279

(51) Int. Cl. G09G 3/36

(52) U.S. Cl. CPC G09G 3/3648
USPC 345/214

(57) ABSTRACT

There is provided a display driver IC including an image memory which stores display data supplied from a host processor, a timing controller which reads the display data from the image memory and drives a connected display panel, and an internal clock oscillation circuit which supplies an internal clock to the timing controller. An oscillation frequency of the internal clock oscillation circuit is calibrated on the basis of an external clock supplied from an external device. An operation of the host processor which supplies the external clock can be suspended, thereby reducing power consumption of a display apparatus as a whole. Therefore, an expensive oscillation vibrator is not necessary, and thus it is possible to minimize an increase in a cost of the display apparatus.

### CROSS-REFERENCE TO RELATED APPLICATIONS

The Present application claims priority from Japanese application JP 2013-097279 filed on May 7, 2013, the content of which is hereby incorporated by reference into this application.

### BACKGROUND

The present invention relates to a display driver integrated circuit (IC), and particularly to a driver IC which displays display data received from a host processor on a display panel.

A display apparatus such as a liquid crystal display (LCD) apparatus includes a display driving device which drives a display panel, and the display driving device generates and outputs signals for driving the display panel, for example, from display data received from a host processor. The display driving device is called an LCD controller, an LCD driver, or a display driver IC, or abbreviated to a display driver, a driver IC, or the like.

JP-A-2001-092423 discloses an LCD controller (display driving device) which has a built-in oscillation circuit generating a clock. The LCD controller displays display data which is supplied from an externally attached system control IC (corresponding to the above-described host processor), on a liquid crystal display panel. The display data is an image signal including digital RGB, and is transmitted from the system control IC to the LCD controller in synchronization with a system clock (refer to paragraphs [0013] to [0016] and FIG. 1 of the same document). An oscillation circuit is built into the LCD controller. The built-in oscillation circuit generates a clock of a different frequency, independently from the system clock, on the basis of an oscillation vibrator. The LCD controller generates control signals for display, such as a horizontal synchronization signal and a vertical synchronization signal, on the basis of the clock (refer to paragraph [0020] and FIG. 2). In techniques hitherto, control signals for display, such as a horizontal synchronization signal and a vertical synchronization signal, have been generated on the basis of the system clock, and thus there is a problem in that a specification change of a display panel or a frequency change of the system clock cannot be flexibly handled (refer to paragraphs [0008] and [0009]). This problem is solved by the technique disclosed in JP-A-2001-092423. The technique pays attention to the fact that, since an image signal is transmitted from the system control IC in synchronization with the system clock, timing adjustment for receiving the image signal is necessary in the LCD controller (refer to paragraph [0023]), but control signals for display such as the horizontal synchronization signal or the vertical synchronization signal may not be synchronized with the system clock (refer to paragraph [0025]).

JP-A-2001-060079 discloses a matrix type display control device whose power consumption is small and which is suitable for large-capacity display. The device includes a host microprocessor unit (MPU), a video random access memory (VRAM), and an LCD module, and transmits display data stored in the VRAM to a frame memory of the LCD module, thereby performing display. In addition, the device includes a module controller. The module controller includes a direct memory access (DMA) circuit which transmits the display data stored in the VRAM to the frame memory of the LCD module, a timing generation circuit which generates a scanning start signal and the like necessary in the LCD module, a low frequency oscillation circuit, and a high frequency oscillation circuit. The low frequency oscillation circuit oscillates a low frequency clock at all times and supplies the low frequency clock to the timing generation circuit, and thus the scanning start signal and the like are supplied to the LCD module at all times. On the other hand, the high frequency oscillation circuit is intermittently operated. The high frequency oscillation circuit is operated only when display data is changed, so as to supply a high frequency clock to the DMA circuit, thereby transmitting the display data. In addition, the device includes an input touch sensor and a touch sensor controller.

JP-A-2012-059265 discloses a display device and a driving method thereof in which an in-cell touch sensor and a display element are alternately operated in a time dividing manner. One frame is divided into display modes and touch sensing modes, and a timing controller controls a gate driver, a data driver, and a touch controller so that both modes are alternately performed. This system intermittently performs image display every several lines, and realizes high touch detection accuracy by performing touch sensing in a period when outputting of an image from a display driver stops. Since noise of a signal for driving the display element is not mixed with a detection signal of the touch sensor, it is possible to reduce an influence of noise.

### SUMMARY

The present inventor has examined JP-A-2001-092423, 2001-060079 and 2012-059265, and, as a result, has found the following new problems.

In a display apparatus such as a liquid crystal display apparatus, low power consumption is a very important issue. As disclosed in JP-A-2001-060079, the frame memory is mounted in the display driver IC, a control signal necessary in display is generated at all times so that display data stored in the frame memory is displayed at all times, and transmission of data to the frame memory is intermittently performed, thereby reducing power consumption for transmission of display data. Here, as disclosed in JP-A-2001-092423, a clock for generating a control signal necessary in display at all times and a clock for transmitting display data may be provided independently from each other, and are not required to be synchronized with each other. In addition, a frequency of a clock for performing display is not required to have absolute accuracy if only a timing specification between various generated control signals has to be observed.

However, as a result of the examination, the present inventor has found that the following problems occur if a clock for performing display and a clock for transmitting display data deviate considerably from an expected relationship. In other words, in a case where a display timing is too early, there is a concern that a problem may occur in which data for display is read from an address of the frame memory to which data has not been transmitted, and thus a displayed image is fuzzy. In contrast, in a case where a display timing is too late, there is a concern that a problem may occur in which transmitted data is overwritten by subsequent data before the data is displayed, and thus a displayed image is fuzzy.

In addition, as disclosed in JP-A-2012-059265, in a case where display and touch sensing are performed in a time dividing manner, the following new problems occur. JP-A-2001-060079 discloses the LCD module provided with a display panel, the input touch sensor, and the touch sensor controller, but discloses no operation timing of display and touch sensing. As disclosed in JP-A-2012-059265, if display and touch sensing are to be performed in a time dividing manner, operation timings with respect to each other are required to be synchronized. In JP-A-2012-059265, the display driver and the touch controller are operated in response to a mode switching signal of a display mode and a touch sensing mode, thereby performing timing control.

As a result of the examination, the present inventor has found that operation timings of display and touch sensing can be synchronized with each other by obtaining an absolute accuracy suitable for clock generation circuits of the display driver and the touch controller as well as by introducing a timing signal such as the mode switching signal. For example, if each clock frequency has an absolute accuracy of 1% or less, an error is a maximum of 2%, and if synchronization is performed once in 100 cycles, clock deviation is restricted to be within two cycles until the next synchronization is performed.

In a case where an absolute accuracy which is high to some extent needs to be obtained in an oscillation frequency of the clock generation circuit, an oscillation circuit connected to an oscillation vibrator is used. If a quartz crystal vibrator is connected, a higher absolute accuracy is obtained than in a case where a ceramic vibrator is connected, but a component cost increases. In order to minimize a component cost, an oscillation circuit is employed in which an oscillation frequency is defined by a time constant (CR time constant) using a resistance and a capacitance instead of the oscillation vibrator, but an absolute accuracy of the oscillation frequency is not high due to manufacturing variation, temperature fluctuation, and operation voltage variation.

An object of the present invention is to increase an absolute accuracy of an oscillation frequency without using an expensive component such as an oscillation vibrator in a clock oscillation circuit which is provided so as to be operated independently without being supplied with a clock from a host processor, in a display driver IC which has a built-in frame memory.

Means for solving the problems will be described below, and other problems and novel features will become apparent from the description of the present specification and the accompanying drawings.

An embodiment is as follows.

In other words, there is provided a display driver IC including an image memory (frame memory) which stores display data supplied from a host processor, a timing controller which reads the display data from the image memory and drives a connected display panel, and an internal clock oscillation circuit which supplies an internal clock to the timing controller. An oscillation frequency of the internal clock oscillation circuit is calibrated on the basis of an external clock supplied from an external device.

An effect achieved by the embodiment will be described briefly as follows.

In other words, an operation of the host processor which supplies the external clock can be suspended, thereby reducing power consumption. Therefore, an expensive oscillation vibrator is not necessary, and thus it is possible to minimize an increase in a cost of a display apparatus.

### BRIEF DESCRIPTION OF THE DRAWINGS

FIG. 1 is a block diagram illustrating a configuration example of a display driver IC according to a first embodiment.

FIG. 2 is a block diagram illustrating a configuration example of a calibration circuit according to the first embodiment.

FIG. 3 is a block diagram illustrating a specific configuration example of the calibration circuit according to the first embodiment.

FIG. 4 is a block diagram illustrating a specific configuration example of a clock generation circuit according to the first embodiment.

FIG. 5 is a timing diagram illustrating an operation example of the display driver IC according to the first embodiment.

FIG. 6 is a block diagram illustrating a configuration example of a display driver IC according to a second embodiment.

### DETAILED DESCRIPTION

### 1. Summary of the Embodiments

First, summary of representative embodiments of the invention disclosed in the application will be described. Reference numerals in drawings in parentheses referred to in description of the summary of the representative embodiments just denote components included in the concept of the components to which the reference numerals are designated.

[1] <Display Driver IC Having Calibrated Clock Generation Circuit Built Thereinto>

A display driver IC (1) according to representative embodiments of the invention disclosed in the application has the following configuration.

The display driver IC (1) includes an image memory (6), a timing controller (4), a clock generation circuit (3), and a calibration circuit (2).

The image memory (6) can store display data. The timing controller (4) reads the display data from the image memory, and performs timing control so as to output a signal for driving a connected display panel (11). The clock generation circuit (3) supplies an internal clock (14) for the timing control to the timing controller. The calibration circuit (2) calibrates a frequency of the internal clock on the basis of an external clock supplied from an external device.

Accordingly, it is possible to suspend an operation of the host processor which supplies an external clock, and thus to reduce power consumption. Since an absolute accuracy of a clock frequency is maintained in a predetermined range through calibration, it is not necessary to use an expensive oscillation vibrator, and it is possible to minimize an increase in a cost of a display apparatus.

[2] <Calibration Using Transmission Clock>

In the above [1], the display driver IC (1) further includes an interface circuit (5) to which the display data (13) and a transmission clock (12) for transmitting the display data are input. The calibration circuit calibrates a frequency of the internal clock on the basis of the transmission clock.

Accordingly, a frequency of the internal clock is calibrated when the host processor transmits the display data, so as to suspend an operation of the host processor in a period when the display data is not transmitted, and thus it is possible to reduce power consumption.

[3] <MIPI>

In the above [2], the interface circuit is configured to be connected to a communication path including a data lane (13) and a clock lane (12) conforming to an MIPI. The display data is input from the data lane, and the transmission clock is input from the clock lane.

Accordingly, in the display apparatus in which display data is input from the communication path conforming to the MIPI, a supply source of the display data can be turned to a pause state such as suspending of an operation thereof in a period when the display data is not transmitted, and thus it is possible to reduce power consumption.

[4] <Automatic Detection of Transmission Clock>

In the above [2] or [3], the display driver IC (1) further includes a clock detection circuit (8).

The calibration circuit is configured to control whether to perform or stop the calibration, and the clock detection circuit is configured to detect whether the transmission clock is input or stopped, and to control the calibration circuit so as to perform the calibration in a period when the transmission clock is input.

Therefore, starting of supply of the transmission clock is automatically detected, and, accordingly, calibration of the internal clock can be performed.

[5] <CR Oscillation Circuit>

In any one of the above [1] to [4], the clock generation circuit includes a resistor (31) and a capacitor (32) which define a frequency of the internal clock, and a value of at least one of the resistor and the capacitor is configured to be changed through the calibration.

Accordingly, even if the inexpensive CR oscillation circuit is used, since an absolute accuracy of an oscillation frequency of the clock generation circuit is restricted within a predetermined range through calibration, an expensive oscillation vibrator is not required to be used, and an increase in a cost of a display apparatus can be minimized.

[6] <Calibration Circuit>

In any one of the above [1] to [5], the calibration circuit is configured to hold a digital value (FOSC2) which defines an oscillation frequency of the clock generation circuit. The calibration circuit includes a counter (21) that counts a width of a timing signal generated on the basis of the external clock by using the internal clock or a divided clock generated by dividing the internal clock, and a comparison circuit (20) that compares a count value of the counter with a predetermined expected value, and is configured to vary the digital value (FOSC2) on the basis of a comparison result from the comparison circuit.

Accordingly, the calibration circuit can be formed by digital logic circuits so that manufacturing variation and temperature and/or power supply voltage dependency of the calibration circuit do not influence an absolute accuracy of an internal clock frequency which is a calibration target.

[7] <Registers which Designate Expected Value and Allowable Range>

In the above [6], the calibration circuit further includes a central value register (25_1) that can store the expected value, and an accuracy register (25_2) that can designate a deviation width which is allowable relative to the expected value. The calibration circuit is configured to vary the digital value (FOSC2) which defines an oscillation frequency of the clock generation circuit when the count value is considerably further deviated from a value stored in the central value register than a value stored in the accuracy register.

Accordingly, a central oscillation frequency of the internal clock generation circuit and an allowable range of accuracy can be appropriately set in accordance with a frequency or an absolute accuracy of an input external clock or an absolute accuracy required in an internal clock, and thus can be used in various display systems. In addition, a value which has been set once can be appropriately changed.

[8] <Trimming in Shipment>

In the above [6] or [7], the calibration circuit further includes a trimming circuit (9) and a calibration register (28). The calibration circuit specifies the digital value (FOSC2) which defines an oscillation frequency of the clock generation circuit on the basis of values stored in the trimming circuit and the calibration register. The calibration circuit is configured to vary a value stored in the calibration register on the basis of a comparison result by the comparison circuit.

Accordingly, the trimming circuit can absorb characteristic fluctuations caused by manufacturing variations, and the calibration register can absorb characteristic fluctuations caused by circumstances such as a temperature or a voltage. Therefore, characteristic fluctuations before calibration such as power being supplied can be minimized, thereby allowing calibration to be performed immediately.

### 2. Further Detailed Description of the Embodiments

The embodiments will be described in further detail.

### First Embodiment

### Display Driver IC Having Calibrated Clock Generation Circuit Built Thereinto

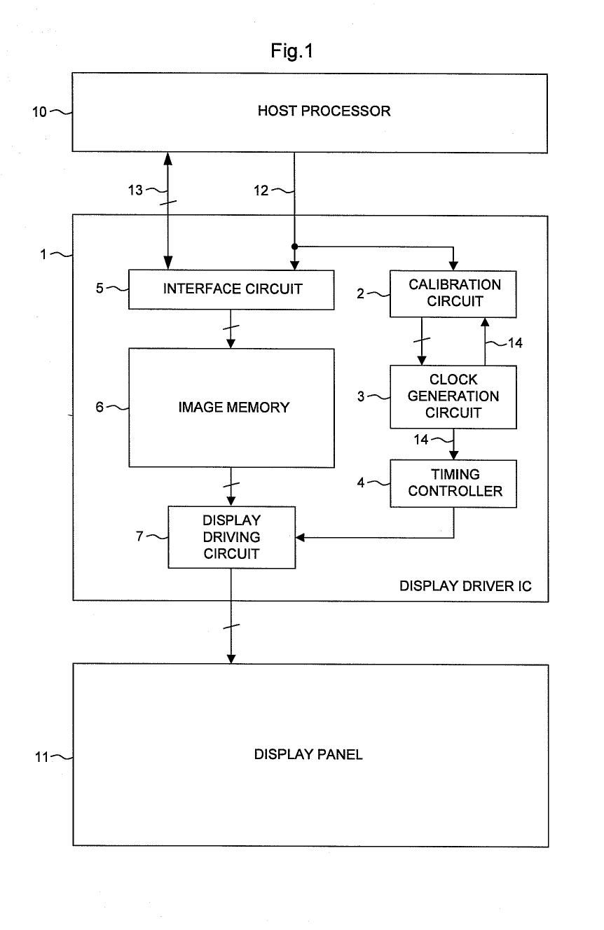

FIG. 1 is a block diagram illustrating a configuration example of a display driver IC according to the first embodiment.

A display driver IC 1 includes an image memory 6, a display driving circuit 7, a timing controller 4, a clock generation circuit 3, and a calibration circuit 2, and outputs driving signals for displaying display data 13 which is supplied from a host processor 10 on a display panel 11. Although not particularly limited, the display driver IC 1 is formed on a single semiconductor substrate such as silicon by using, for example, a well-known semiconductor manufacturing technique. The display panel 11 may be any display panel such as a liquid crystal display panel, an organic electroluminescence (EL) display panel, or a plasma display panel.

The image memory 6 is, for example, a frame memory which can store display data of one frame for display on the display panel 11, and stores the display data 13 supplied from the host processor 10. The image memory may have a storage capacity capable of storing display data of a plurality of frames. Although not particularly limited, the image memory 6 is formed by a static random access memory (SRAM).

The timing controller 4 reads the display data from the image memory 6, and performs timing control so as to output a signal for driving the connected display panel 11. The display data read from the image memory 6 is converted into a driving signal for driving the display panel 11 and is output in the display driving circuit 7. The display data is a digital value and is thus converted into an analog signal waveform with an appropriate amplitude, and is output at an appropriate timing. For example, if the liquid crystal display panel is to be driven, a line to be driven is selected using a gate signal, and a luminance signal of a color of each pixel of the selected line is transmitted using a source signal.

The clock generation circuit 3 supplies an internal clock 14 for the timing control to the timing controller 4. The calibration circuit 2 calibrates a frequency of the internal clock 14 on the basis of an external clock 12 supplied from an external device.

Generally, since the display panel does not hold information on luminance or a color which is displayed for a long time over a plurality of frames, for example, in a case where a still image is displayed, the same data is required to be repeatedly read and displayed on the display panel. In a case where the display driver IC does not have a built-in image memory (frame memory), display data is required to be repeatedly transmitted to the display driver IC, but in a case where the image memory (frame memory) 6 is built into the display driver IC, the display data 13 supplied from the host processor 10 may be stored in the image memory 6, and the same data may be repeatedly read from the image memory 6 so as to be displayed. After display data of one frame is transmitted, the host processor 10 can be transferred to a low power consumption operation mode such as suspending of an operation.

In this case, the display driver IC 1 according to the first embodiment of the present invention has the built-in clock generation circuit 3 which generates the internal clock 14. For this reason, it is not necessary to supply a clock from an external device such as the host processor 10 in order to supply a clock to the timing controller 4. The host processor 10 can transition to a deep standby state so as to stop a clock thereof, and thus it is possible to reduce power consumption as a whole of the display apparatus. In addition, the clock generation circuit 3 may employ an oscillation circuit which is oscillated on the basis of a CR time constant without using an expensive component such as a quartz crystal vibrator or a ceramic vibrator. There is a concern that an oscillation frequency may vary depending on manufacturing variations or operation circumstances (a temperature, a power supply voltage, and the like). Therefore, in the present invention, the calibration circuit 2 is provided.

Accordingly, it is possible to suspend an operation of the host processor which supplies an external clock, and thus to reduce power consumption. Since an absolute accuracy of a clock frequency is maintained in a predetermined range through calibration, it is not necessary to use an expensive oscillation vibrator, and it is possible to minimize an increase in a cost of the display apparatus.

<Calibration Using Transmission Clock>

The display driver IC 1 may further include an interface circuit 5 to which the display data 13 and a transmission clock for transmitting the display data are input. The calibration circuit 2 calibrates a frequency of the internal clock 14 on the basis of the input transmission clock 12 when the display data 13 is transmitted.

Accordingly, a frequency of the internal clock is calibrated when the host processor transmits the display data, so as to suspend an operation of the host processor in a period when the display data is not transmitted, and thus it is possible to reduce power consumption.

Meanwhile, an external clock for display may be input separately from the transmission clock, and the clock generation circuit 3 may output the internal clock 14 on the basis of the external clock. In this case, the calibration circuit 2 calibrates a frequency of the internal clock 14 on the basis of the external clock. In addition, both of the transmission clock and the external clock may be input to the calibration circuit 2, and the calibration may be performed on the basis of a clock selected by the calibration circuit 2.

<MIPI>

The interface circuit 5 may be configured to be connected to a communication path including the data lane 13 and the clock lane 12 conforming to an MIPI. Here, MIPI stands for a mobile industry processor interface, and is a communication interface standard for portable apparatuses, which has been formulated by an MIPI alliance constituted by a plurality of companies. Display data is input from the data lane 13, and a transmission clock is input from the clock lane 12.

Accordingly, in the display apparatus in which display data is input from the communication path conforming to the MIPI, a supply source of the display data can be turned to a pause state such as suspending of an operation thereof in a period when the display data is not transmitted, and thus it is possible to reduce power consumption.

<Calibration Circuit>

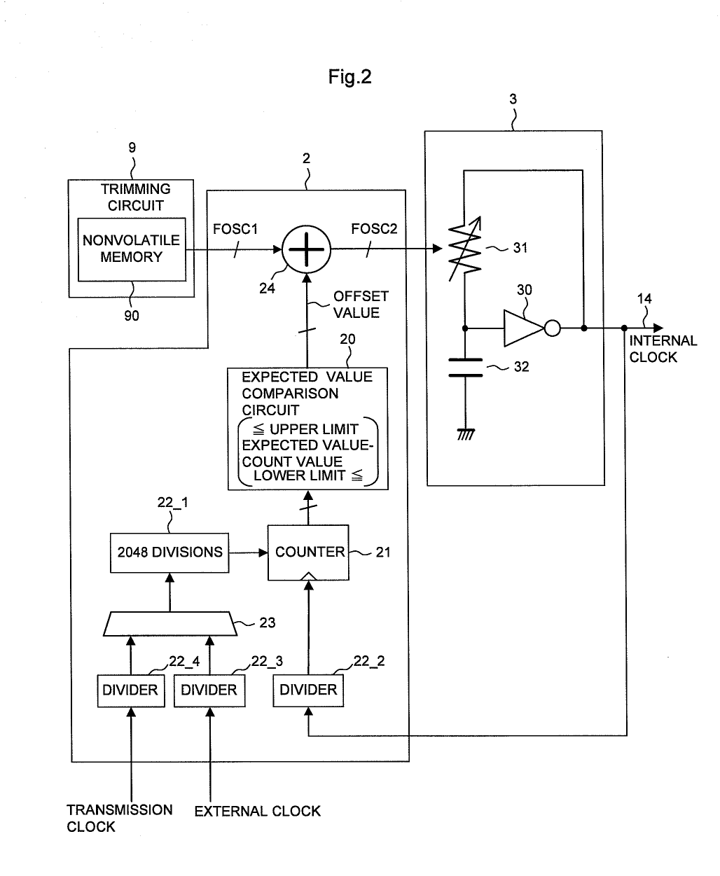

FIG. 2 is a block diagram illustrating a configuration example of the calibration circuit according to the first embodiment.

The calibration circuit 2 supplies, to the clock generation circuit 3, a digital value FOSC2 which defines an oscillation frequency thereof. The calibration circuit 2 includes an expected value comparison circuit 20, and adjusts an oscillation frequency of the clock generation circuit 3 by varying the digital value FOSC2 on the basis of a comparison result. The expected value comparison circuit 20 compares a count value of a counter 21 with a predetermined expected value, and the counter 21 counts a width of a timing signal which is generated on the basis of the above-described transmission clock of display data or other external clock, by using the internal clock 14 or a divided clock which is generated by dividing the internal clock.

The expected value comparison circuit 20 may be formed by all digital logic circuits such as a counter, a divider, and a comparator. Therefore, the calibration circuit can be configured so that manufacturing variation and temperature and/or power supply voltage dependency of the calibration circuit do not influence an absolute accuracy of an internal clock frequency which is a calibration target.

FIG. 2 illustrates a more specific configuration example of the calibration circuit 2. The calibration circuit 2 is connected to a trimming circuit 9, and receives a trimming value FOSC1 stored in a nonvolatile memory 90. The nonvolatile memory 90 may be a nonvolatile memory which is electrically rewritable, and may be a fuse which is fused when laser light or an electrical signal is applied thereto. The trimming value FOSC1 is, for example, an adjustment value for allowing an oscillation frequency of the clock generation circuit 3 to reach an expected value if at all possible, in a characteristic test before shipment, and thus a fluctuation in the oscillation frequency caused by a manufacturing variation is compensated for.

The calibration circuit 2 includes an adder 24 which adds an offset value to the trimming value FOSC1 so as to supply the digital value FOSC2 which defines an oscillation frequency to the clock generation circuit 3. The trimming value FOSC1 compensates for a fluctuation in an oscillation frequency caused by a manufacturing variation, whereas the offset value compensates for fluctuations in the oscillation frequency caused by variations in operation circumstances such as a temperature or a power supply voltage. Accordingly, characteristic fluctuations before calibration such as power being supplied can be minimized, thereby allowing calibration to be preformed immediately.

The calibration circuit 2 includes the expected value comparison circuit 20 which varies the offset value on the basis of a comparison result so as to vary the digital value FOSC2, thereby adjusting an oscillation frequency of the clock generation circuit 3. A count value of the counter 21 is input to the expected value comparison circuit 20. When a difference between an expected value held therein and a count value is greater than an upper limit or smaller than a lower limit, the offset value is adjusted.

The above-described transmission clock of display data and external clock are input to the calibration circuit 2. Both clocks are respectively divided by dividers 22_4 and 223, and one thereof is selected by a selector 23 so as to be divided by a divider 22_1 of 2048 divisions. A divided clock which is obtained by dividing the internal clock 14 in a divider 22_2 is input to the counter 21. The counter 21 counts the clock for example, only during a high interval of the input signal of 2048 divisions.

For example, if the external clock is 28 MHz, and the internal clock is 56 MHz, the divider 22_3 does not divide the external clock (one division), the selector 23 selects the external clock side which is divided by 2048 in the divider 22_1, and, as a result, a high interval is 36.6 μs. The internal clock 14 is divided by 2 in the divider 22_2, and the high interval is counted by the counter 21. If a frequency of the internal clock is 56 MHz as expected, a count value is 1024, and thus this is an expected value. In order to restrict accuracy to a range of ±1%, the expected value comparison circuit 20 varies the offset value when a difference between the expected value and the count value exceeds ±10, thereby adjusting a frequency of the internal clock 14.

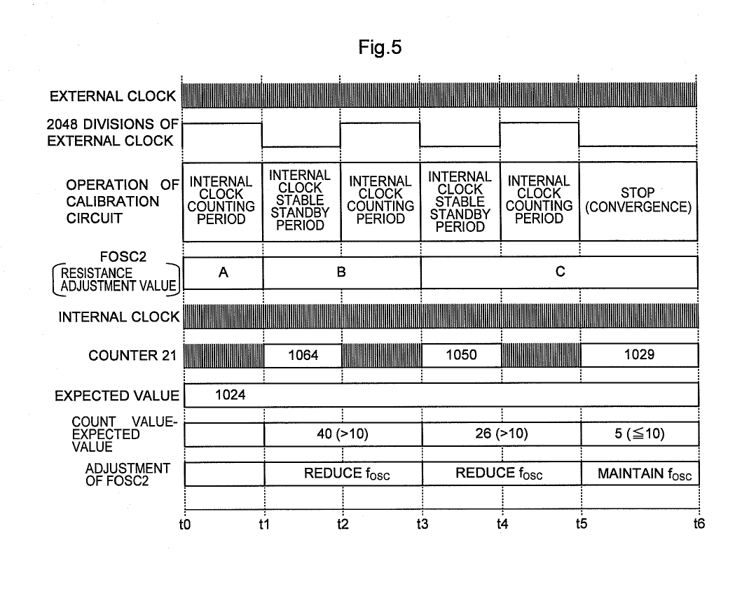

FIG. 5 is a timing diagram illustrating an operation example of the display driver IC according to the first embodiment. The transverse axis expresses the time, and the longitudinal axis expresses, from the above, the external clock, a waveform of a signal obtained by dividing the external clock by 2048, an operation of the calibration circuit 2, a value of FOSC2, the internal clock 14, the expected value, (count value−expected value), and an adjustment operation of FOSC2. The time t0 to t1 is a high interval of the signal obtained by dividing the external clock by 2048, and the counter 21 performs a count-up operation. A count value is 1064 at the time point t1 when the high interval of the signal obtained by dividing the external clock by 2048 ends. The expected value comparison circuit 20 compares the count value with the expected value. The expected value is constant as 1024, and a difference from the count value is 40 which exceeds ±10. Therefore, FOSC2 is updated from “A” to “B” so as to reduce an oscillation frequency f_{OSC} of the internal clock 14. If FOSC2 is changed, an oscillation operation of the clock generation circuit 3 requires a period of some extent until stabilizing. The time t1 to t2 is an internal clock stable standby period, and a counting operation is not performed. The calibration circuit 2 performs a counting operation again in the next high interval of the signal obtained by dividing the external clock by 2048 during the time t2 to t3. A count value is 1050 at the time point t3, and the expected value comparison circuit 20 compares the count value with the expected value. A difference therebetween is 26 which exceeds ±10, and thus FOSC2 is updated from “B” to “C” so as to further reduce the oscillation frequency f_{OSC} of the internal clock 14. A counting operation is performed again during the time t4 to t5 after an internal clock stable standby period of the time t3 to t4. A count value is 1029 at the time point t5, and, if the expected value comparison circuit 20 compares the count value with the expected value, a difference therebetween is 5 and is thus in a range of ±10. Therefore, it can be seen that a frequency of the internal clock 14 has an accuracy within ±1% of desired 56 MHz. FOSC2 is not updated at the time point t5, and an operation of the clock generation circuit 3 is maintained. The calibration circuit 2 stops a calibration operation at the time point t5. On the other hand, the calibration circuit 2 may continuously perform the calibration operation thereafter. If the calibration operation is stopped, power consumption of the display apparatus can be reduced, and, on the other hand, if the calibration operation is continuously performed, a frequency of the internal clock can be restricted to be within a range of a specific absolute accuracy in tracking of a fluctuation in a temperature or a power supply voltage.

This is also the same for a case of performing a calibration operation on the basis of the transmission clock instead of the external clock.

For example, if the transmission clock is 1 GHz for the clock lane of the MIPI, and the internal clock is 56 MHz, the transmission clock is divided by 40 in the divider 22_4, and thus a clock of 25 MHz is generated. The transmission clock side is selected by the selector 23 and is then divided by 2048 in the divider 22_1, and thus a high interval thereof is 40.96 The internal clock 14 is divided by 2 in the divider 22_2, and the counter 21 counts the high interval. If a frequency of the internal clock is 56 MHz as expected, a count value is 1147, and this is an expected value. In order to restrict accuracy to be within a range of ±1%, the expected value comparison circuit 20 varies the offset value when a difference between the expected value and the count value exceeds ±11, thereby adjusting a frequency of the internal clock 14.

<Registers which Designate Expected Value and Allowable Range>

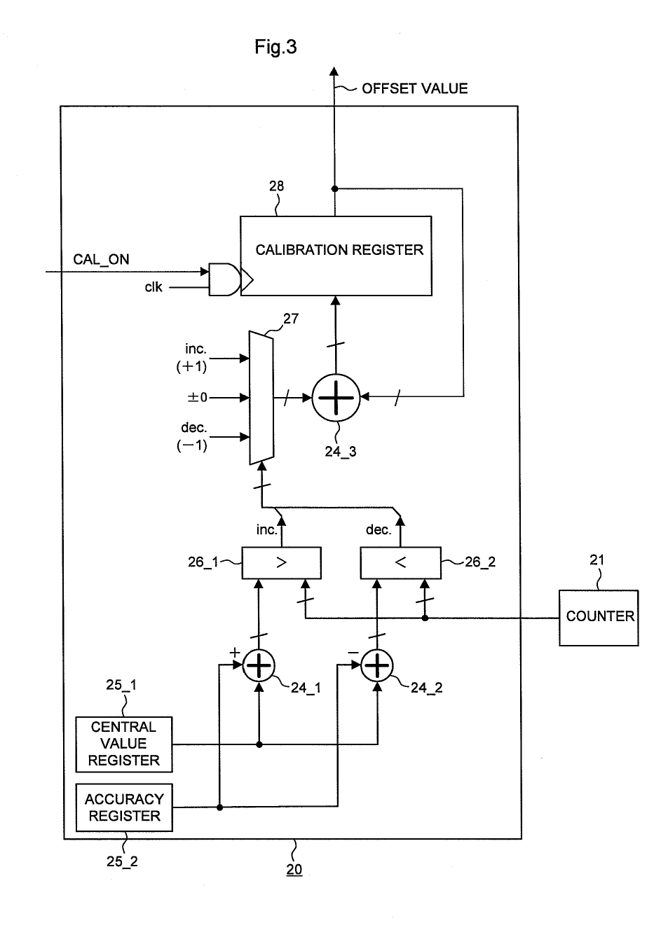

FIG. 3 is a block diagram illustrating a specific configuration example of, particularly, the expected value comparison circuit 20 of the calibration circuit 2 according to the first embodiment. The calibration circuit 2 includes a central value register 25_1 which can store an expected value in the expected value comparison circuit 20, an accuracy register 25_2 which can designate a deviation width which is allowable relative to the expected value, and a calibration register 28 which holds the offset value.

A sum of the central value register 25_1 and the accuracy register 25_2 is calculated by an adder 24_1 so as to be input to a comparator 26_1, and a difference is calculated by an adder 24_2 so as to be input to a comparator 26_2. The comparators 26_1 and 26_2 respectively compare a count value of the counter 21 with (central value+accuracy) and (central value−accuracy). Comparison results are output to a selector 27.

An output of the calibration register 28 is fed back via the adder 24_3, and is updated by the output value of the adder 24_3 in a period when an input CAL_ON signal is asserted. The adder 24_3 adds (inc.) or subtracts (dec.) a value selected by the selector 27 to or from an offset value before being updated, or adds 0 thereto so as to maintain the offset value. The selector 27 performs control for increasing, decreasing, or maintaining the offset value, on the basis of comparison results of the comparators 26_1 and 26_2. Values which are added and subtracted exemplify cases of +1 and −1 for simplification but may be appropriately adjusted on the basis of a magnitude of a difference between a count value and an expected value stored in the central value register 25_1. When a frequency of the internal clock 14 deviates considerably from an expected value, an adjustment amount of an offset value is made large, and thus convergence can be made to arrive early. When a frequency of the internal clock 14 is close to an expected value, an adjustment amount of the offset value is made small, and a fluctuation width of a frequency can be minimized and stabilized.

The calibration circuit 2 is configured to vary the digital value FOSC2 which defines an oscillation frequency of the clock generation circuit 3 when a count value of the counter 21 deviates considerably further from a value stored in the central value register 25_1 than a value stored in the accuracy register 25_2. Accordingly, a central oscillation frequency of the internal clock generation circuit and an allowable range of accuracy can be appropriately set in accordance with a frequency or an absolute accuracy of an input external clock or an absolute accuracy required in an internal clock, and thus can be used in various display systems. In addition, a value which has been set once can be appropriately changed.

<CR Oscillation Circuit>

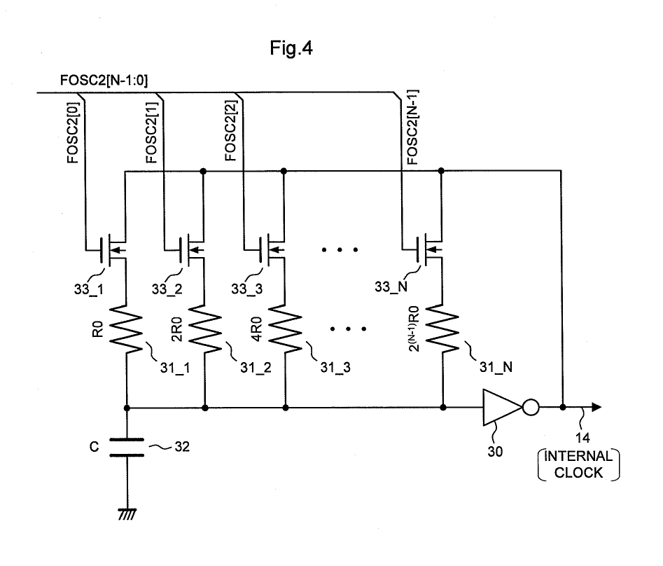

FIG. 4 is a block diagram illustrating a more specific configuration example of the clock generation circuit according to the first embodiment.

The clock generation circuit 3 includes resistors 31 (31_1 to 31_N) and a capacitor 32 which define a frequency of an internal clock, and a value of at least one of the resistors and the capacitor can be changed through calibration. The clock generation circuit is an oscillation circuit in which an output of an inverter 30 is the internal clock 14, and the output is fed back to an input side of the inverter via the resistors 31. The grounded capacitor 32 is connected to the input side of the inverter 30, and an oscillation frequency is defined on the basis of a CR time constant which is a product of values of the resistors 31 and the capacitor 32. The resistors 31 are constituted by connecting respective series connections of the resistors 31_1 to 31_N and switches 33_1 to 33_N which are MOS transistors, in parallel to each other. Gates of the switches 33_1 to 33_N are controlled by FOSC2. The resistors 31_1 to 31_N may include resistors having resistance values of R0, 2R0, 4R0, . . . , and 2^{(N-1)}R0 which increase with the power of 2. A value of the composite resistors 31 is a product of a numerical value in a binary expression of FOSC2 and R0. Accurately, values obtained by subtracting On-resistances of the switches 33_1 to 33_N from resistance values of the respective resistors 31_1 to 31_N, are set to resistance values of R0, 2R0, 4R0, . . . , and 2^{(N-1)}R0.

Accordingly, even if the inexpensive CR oscillation circuit is used, since an absolute accuracy of an oscillation frequency of the clock generation circuit is restricted to be within a predetermined range through calibration, an expensive oscillation vibrator is not required to be used, and an increase in a cost of a display apparatus can be minimized.

FIG. 4 exemplifies the CR oscillation circuit in which the resistors and the switches are connected in parallel so as to adjust resistance values, but the oscillation circuit may also have other configurations. For example, a resistance value may be adjusted using a ladder type of R-2R or resistors which are connected in series to each other. In addition, capacitance values of a plurality of capacitors may be adjusted by controlling turning on and off of switches, and both of capacitance values and resistance values may be adjusted.

### Second Embodiment

### Automatic Detection of Transmission Clock

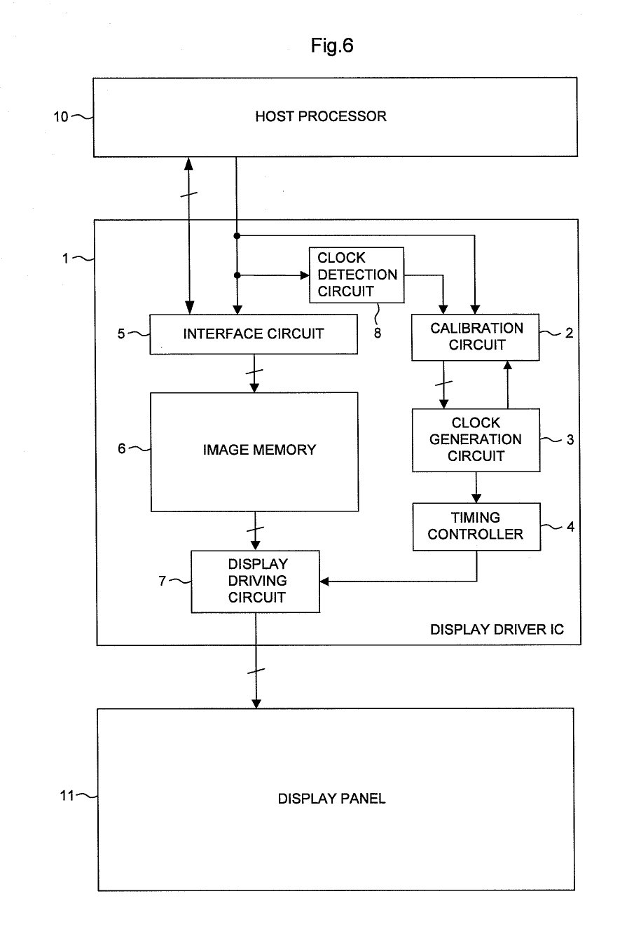

FIG. 6 is a block diagram illustrating a configuration example of a display driver IC according to a second embodiment.

A difference from the first embodiment illustrated in FIG. 1 is that the display driver IC 1 further includes a clock detection circuit 8. Other constituent elements are the same as those in the first embodiment, and description thereof will not be repeated.

The calibration circuit 2 is configured to control whether calibration is performed or stopped. The clock detection circuit 8 can detect whether the transmission clock 12 is input or stopped, and causes the calibration circuit 2 to perform calibration in a period when the transmission clock 12 is input.

Therefore, starting of supply of the transmission clock is automatically detected, and, accordingly, calibration of the internal clock can be performed.

As mentioned above, although the invention made by the present inventor has been described in detail on the basis of the embodiments, the present invention is not limited thereto and may have various modifications in the scope without departing from the spirit thereof.

For example, the calibration circuit may be configured to compare a frequency of an internal clock with a frequency of a clock supplied from an external device. In contrast to the above-described embodiments, a counter may be provided which counts a width of a timing signal generated on the basis of an internal clock, by using an external clock or a divided clock thereof, and calibration may be performed. In addition, a phase comparator formed by an analog circuit may be used.

In addition, for example, the clock generation circuit may be changed to oscillation circuits other than the CR oscillation circuit. In a ring oscillator using inverters of odd-numbered stages, an oscillation circuit may be configured in which an oscillation frequency can be adjusted by inserting a current source which can restrict an operation current into a power supply of each inverter.

What is claimed is:

1. A display driver IC comprising:
an image memory that can store display data;
a timing controller that reads the display data from the image memory, and performs timing control so as to output a signal for driving a connected display panel;
a clock generation circuit that supplies an internal clock for the timing control to the timing controller; and
a calibration circuit that performs calibration of a frequency of the internal clock on the basis of an external clock supplied from an external device.

2. The display driver IC according to claim 1, further comprising an interface circuit that receives the display data and a transmission clock for transmitting the display data,
wherein the calibration circuit performs calibration of a frequency of the internal clock on the basis of the transmission clock.

3. The display driver IC according to claim 2, wherein the interface circuit is configured to be connected to a communication path including a data lane and a clock lane which conform to an MIPI, and
wherein the display data is input from the data lane, and the transmission clock is input from the clock lane.

4. The display driver IC according to claim 2, further comprising a clock detection circuit,
wherein the calibration circuit is configured to control whether to perform or stop the calibration, and
wherein the clock detection circuit is configured to detect whether the transmission clock is input or stopped, and to control the calibration circuit so as to perform the calibration in a period when the transmission clock is input.

5. The display driver IC according to claim 3, further comprising a clock detection circuit,
wherein the calibration circuit is configured to control whether to perform or stop the calibration, and
wherein the clock detection circuit is configured to detect whether the transmission clock is input or stopped, and to control the calibration circuit so as to perform the calibration in a period when the transmission clock is input.

6. The display driver IC according to claim 1, wherein the clock generation circuit includes a resistor and a capacitor which define a frequency of the internal clock, and a value of at least one of the resistor and the capacitor is configured to be changed through the calibration.

7. The display driver IC according to claim 1, wherein the calibration circuit is configured to hold a digital value which defines an oscillation frequency of the clock generation circuit, and
wherein the calibration circuit includes a counter that counts a width of a timing signal generated on the basis of the external clock by using the internal clock or a divided clock generated by dividing the internal clock, and a comparison circuit that compares a count value of the counter with a predetermined expected value, and is configured to vary the digital value on the basis of a comparison result from the comparison circuit.

8. The display driver IC according to claim 7, wherein the calibration circuit further includes a central value register that can store the expected value, and an accuracy register that can designate a deviation width which is allowable relative to the expected value, and
wherein the calibration circuit is configured to vary the digital value which defines an oscillation frequency of the clock generation circuit when the count value deviates considerably further from a value stored in the central value register than a value stored in the accuracy register.

9. The display driver IC according to claim 7, wherein the calibration circuit further includes a trimming circuit and a calibration register,
wherein the calibration circuit specifies the digital value which defines an oscillation frequency of the clock generation circuit on the basis of values stored in the trimming circuit and the calibration register, and
wherein the calibration circuit is configured to vary a value stored in the calibration register on the basis of a comparison result from the comparison circuit.

10. The display driver IC according to claim 8, wherein the calibration circuit further includes a trimming circuit and a calibration register,
wherein the calibration circuit specifies the digital value which defines an oscillation frequency of the clock generation circuit on the basis of values stored in the trimming circuit and the calibration register, and
wherein the calibration circuit is configured to vary a value stored in the calibration register on the basis of a comparison result from the comparison circuit.
